(19) United States
(12) Patent Application Publication
(10) Pub. No.: US 2003/0107986 A1
(43) Pub. Date: Jun. 12, 2003

(54) Method and apparatus for demodulating orthogonal frequency division multiplexed signals

(75) Inventors: Robert Conrad Malkemes, Bricktown, NJ (US); Henry Sedwick Miiller, Yardley, PA (US)

Correspondence Address: MOSER, PATTERSON & SHERIDAN, LLP, /SARNOFF CORPORATION, 595 SHREWSBURY AVENUE, SUITE 100, SHREWSBURY, NJ, 07702, US

(73) Assignee: Sarnoff Corporation

(21) Appl. No.: 10/013,571

(22) Filed: Dec. 11, 2001

(51) Int. Cl. H04J 11/00

(52) U.S. Cl. 370/208; 370/480

(57) ABSTRACT

A method and apparatus for demodulating an orthogonal frequency division multiplexed (OFDM) signal. Specifically, the OFDM demodulator includes a band edge timing recovery circuit for tracking the symbol timing error and a programmable delay circuit for optimally re-sampling the OFDM signal under control of the band edge timing circuit to correct the symbol timing error. Symbol timing is recovered independent of synchronizing and training sequences in the OFDM signal, which results in reduced intercarrier interference when the sub-carriers of the OFDM signal are recovered.

### BACKGROUND OF THE INVENTION

1. Field of the Invention

The present invention generally relates to an apparatus for receiving and processing orthogonal frequency division multiplexed (OFDM) signals and, more particularly, to an OFDM receiver that employs band edge timing recovery to reduce intercarrier interference.

2. Description of the Related Art

Orthogonal frequency division multiplexing (OFDM) is a robust technique for efficiently transmitting data over a channel. The technique uses a plurality of sub-carrier frequencies (sub-carriers) within a channel bandwidth to transmit the data. These sub-carriers are arranged for optimal bandwidth efficiency in that the frequency spectra of OFDM sub-carriers overlap significantly within the OFDM channel bandwidth. OFDM nonetheless allows resolution and recovery of the information that has been modulated onto each sub-carrier. Additionally, OFDM is much less susceptible to data loss due to multipath fading that other conventional approaches for data transmission because inter-symbol interference (ISI) is prevented through the use of OFDM symbols that are long in comparison to the length of the channel impulse response. Longer symbol intervals are possible due to the data being transmitted in parallel on multiple sets of symbols. Accordingly, OFDM has been presented to the industry as an effective technique for combating multipath fading such as that encountered in wireless local area network (WLAN) systems.

Typically, the sub-carriers are demodulated by a fast Fourier Transform (FFT) process. In general, symbol-by-symbol phase and timing characteristics are not recovered when demodulating OFDM signals. Instead, the OFDM system is fully dependent upon training sequences, adequate guard intervals, and the continuous presence of one or more sub-carrier “pilot” signals located within the transmitted OFDM signal in order to maintain reliable FFT demodulation of the sub-carriers. However, in sever multipath environments, where the peak Doppler frequency becomes a significant percentage of the sub-carrier frequency spacing, the symbols transmitted that carry the training data can become corrupted. Thus, in highly time-variant channels, the OFDM demodulation process generates intercarrier interference in the FFT.

Therefore, there exists a need in the art for a method and apparatus for demodulating an OFDM signal that can achieve accurate symbol timing adjustments in severe multipath environments, and is independent of special synchronization and training signals embedded in the OFDM symbol stream.

### SUMMARY OF THE INVENTION

The disadvantages associated with the prior art are overcome by the present invention of an orthogonal frequency division multiplexed (OFDM) signal demodulator employing band edge timing recovery to reduce intercarrier interference (ICI). Specifically, the OFDM demodulator comprises a front end for producing in-phase (I) and quadrature (Q) signals from a received OFDM signal. The I and Q signals are coupled to a programmable delay circuit that optimally resamples the signals under the control of a band edge timing recovery circuit in order to track the symbol timing error. The band edge timing recovery circuit processes the I and Q signals to recover band edge timing characteristics and generates a band edge timing signal. The optimally resampled signal is temporally equalized to remove intersymbol interference (ISI), and a fast Fourier Transform (FFT) process is performed to demodulate the sub-carriers of the OFDM signal.

### BRIEF DESCRIPTION OF THE DRAWINGS

So that the manner in which the above recited features of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 depicts a block diagram of an OFDM receiver in accordance with the present invention;

FIG. 2 depicts a detailed block diagram of a demodulator having a bandedge timing recovery circuit; and

FIG. 3 depicts a detailed block diagram of a signal processor used in the OFDM receiver of FIG. 1.

### DETAILED DESCRIPTION OF THE PREFERRED EMBODIMENT

The present invention will be described in terms of a wireless local area network (WLAN), such as one compliant with the IEEE 803.11a standard. A 5 GHz wireless band is the typical band used with short-range, high-speed WLANs used in home or office-like environments. As understood by those skilled in the art, however, the present invention is applicable to any receiver in a digital transmission system transmitting orthogonal frequency multiplexed (OFDM) signals.

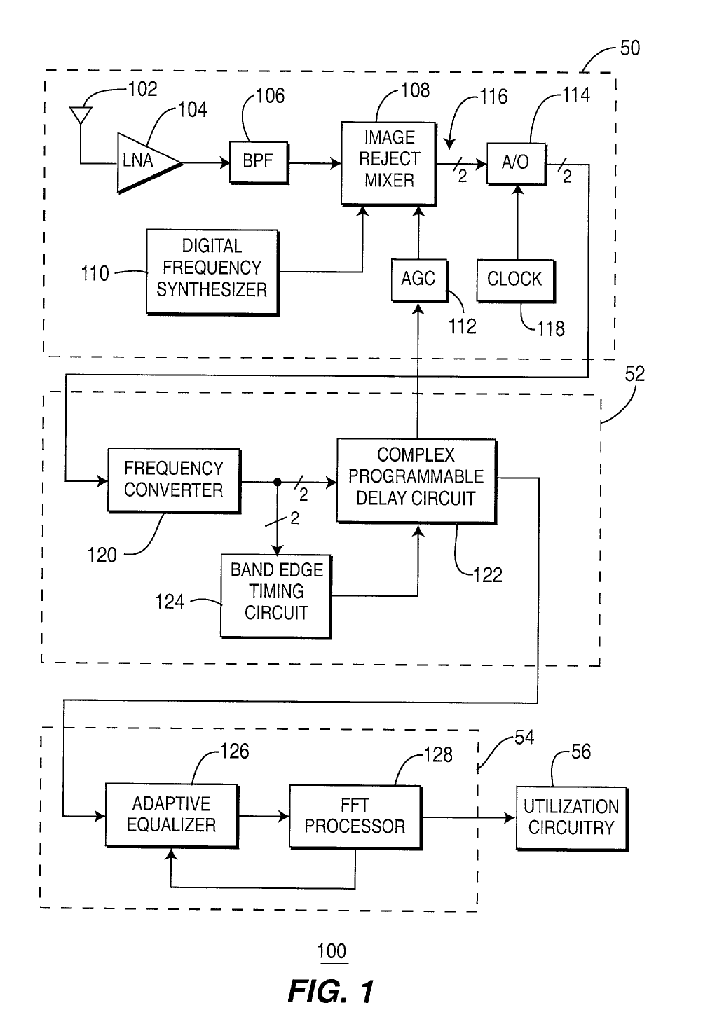

FIG. 1 depicts a block diagram of an OFDM receiver 100 in accordance with the present invention. The OFDM receiver 100 comprises a radio frequency/intermediate frequency (RF/IF) front end 50, a demodulator 52, a signal processor 54, and utilization circuitry 56. The RF/IF front end 50 selects one channel of information for receipt from multiple available channels carried by the transmission medium, such as a WLAN, and generates a digitized in-phase (I) IF signal and a digitized quadrature (Q) IF signal. The demodulator 52 demodulates the digitized I and Q signals to generate a near baseband OFDM signal. Important features of the present invention are found in the band edge timing recovery circuit 124 of the demodulator 52. Specifically, the band edge timing recovery circuit 124 allows for symbol timing and phase synchronization of the OFDM signal without the use of embedded synchronization signals (i.e., training signals). Such training signals could be corrupted in severe multipath environments, resulting in intercarrier interference (ICI) when the OFDM sub-carriers are demodulated.

The output of the demodulator 52 is coupled to the signal processor 54, where the near baseband OFDM signal is temporally equalized to remove inter-symbol interference (ISI). In addition, the signal processor 54 demodulates the OFDM sub-carriers via a fast Fourier Transform (FFT) process in a known manner to generate a sequence of frequency domain sub-symbols that encode the data stream. The output of the signal processor 54 is coupled to the utilization circuitry 56 where, for example, the frequency domain sub-symbols are decoded to recover the transmitted data. Although the present invention is described in terms of functional blocks (i.e., RF/IF front end 50, demodulator 52, and signal processor 54), those skilled in the art understand that some of the several components comprising the functional blocks described herein can comprise a single device, such as an application specific integrated circuit (ASIC) device. Alternatively, some or all of the functional blocks may be implemented in software.

Returning to FIG. 1, the RF/IF front end 50 comprises an RF signal source 102, a low-noise amplifier 104, a band-pass filter 106, an image-reject mixer 108, a digital frequency synthesizer 110, an automatic gain control (AGC) circuit 112, analog-to-digital (A/D) converter 114, and a sampling clock 118. The low-noise amplifier 104 amplifies an RF OFDM-modulated signal received by the RF source 102 (e.g., an antenna or other signal input port or device). The band-pass filter 106 is coupled to the low-noise amplifier 104 and band-limits the RF OFDM signal. The image-reject mixer 108 receives the RF OFDM signal from the band-pass filter 106, selects the desired channel from the available channels in the transmission medium, and converts the RF signal to an IF signal. In an alternative embodiment of the invention, the image reject mixer 108 is a direct conversion mixer that generates a baseband signal, rather than an IF signal.

The image-reject mixer has as an output 116 an in-phase (I) signal and a quadrature (Q) signal, which together represent the complex-valued IF signal. The image-reject mixer 108 generally contains mixers, filters, and summers, all of which are connected in a known manner. In addition, the image-reject mixer 108 contains voltage controlled amplifiers that alter the gain of the IF output signals in accordance with an AGC signal from the AGC circuit 112. In one embodiment, the image-reject mixer 108 comprises a two-stage Gilbert cell mixer as is known in the art. The digital frequency synthesizer 110 is coupled to the image-reject mixer 108 and provides the signals for tuning control. In an alternative embodiment of the invention, the image reject mixer 108 is a direct conversion mixer that generates a baseband signal, rather than an IF signal.

The I and Q signals from the image-reject mixer 108 are coupled to A/D converter 114. The A/D converter digitizes the I and Q signals in accordance with a sampling rate set by the sampling clock 118. The sampling clock 118 is a “free running” oscillator and is thus independent of symbol frequency and phase. In addition, the A/D converter 114 “oversamples” the I and Q signals. As will be described below, the present invention compensates for any sampling rate offset in the demodulator 52 to recover the exact symbol frequency.

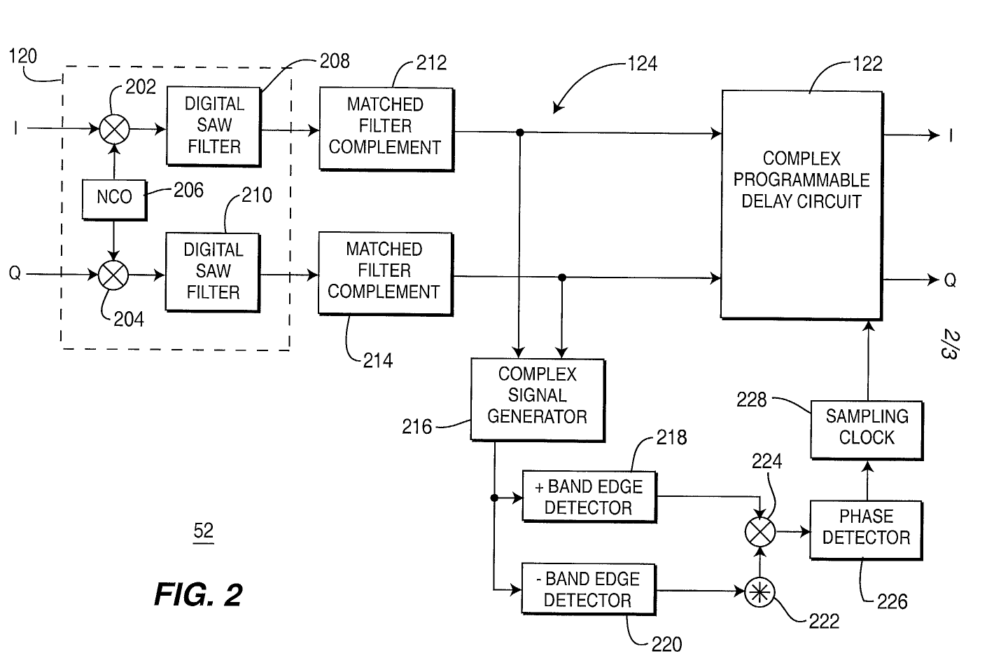

The demodulator 52 comprises a frequency converter 120, a complex programmable delay circuit 122, and a band edge timing recovery circuit 124. The frequency converter 120 receives the digitized I and Q signals from the A/D converters 114 and 116, and downconverts the two signals from IF signals to passband signals centered about or near DC. The passband I and Q signals are coupled to the band edge timing circuit 124, which in turn is coupled to the complex programmable delay circuit 122. As described more fully below with regard to FIG. 2, the complex programmable delay circuit 122 adjusts the passband I and Q signals to compensate for symbol timing and phase error (i.e., synchronization) using a timing signal from the band edge timing recovery circuit 124. The present invention achieves synchronization of the OFDM signal without the use of embedded synchronization signals or training signals that can become corrupted in severe multipath environments. Thus, in highly time-variant channels, where the peak Doppler frequency becomes a significant percentage of the OFDM sub-carrier frequency spacing, ICI in the FFT process is reduced, resulting in an improvement in bit error rate (BER) performance. The output of the complex programmable delay circuit 122 contains I and Q synchronized near baseband signals.

The I and Q near baseband signals from the demodulator 52 are coupled to the signal processor 54. The signal processor 54 comprises an adaptive equalizer 126 and an FFT processor 128. The adaptive equalizer 126 processes the near baseband I and Q signals using adaptive equalization techniques to remove ISI. The adaptive equalizer generates an equalized OFDM baseband signal. The equalized OFDM baseband signal is coupled to the FFT processor 128, where an FFT process is performed to demodulate the OFDM sub-carriers. The demodulated sub-carriers contain frequency domain sub-symbols that encode the data stream. The frequency domain sub-symbols are made available to the utilization circuitry 156 for decoding and data recovery. In addition, as discussed below, the FFT processor 128 provides feedback to the adaptive equalizer 126 for control of the equalizer tap weights. Since FFT processing is typically 4 to 10 times long than the maximum impulse response time of the channel, the present invention advantageously places the adaptive equalizer 126 before the FFT processor 128. As such, the present invention reduces interference before the FFT process, resulting in improved ICI performance.

FIG. 2 depicts a more detailed block diagram of the demodulator 52. Specifically, the frequency converter 120 comprises a pair of mixers 202 and 204, a numerically controlled oscillator (NCO) 206, and a pair of digital surface acoustic wave (SAW) filters 208 and 210. As described above, the frequency converter 120 downconverts the I and Q signals at IF to passband I and Q signals centered about or near DC. The I and Q signals from the A/D converters 114 and 116 are coupled to mixers 202 and 204, respectively. Mixers 202 and 204 downconvert the I and Q signals using an oscillator signal from the NCO 206. The NCO 206 is free running. The outputs of the mixers 202 and 204 are coupled to digital SAW filters 208 and 210, respectively. Digital SAW filters 208 and 210 are low-pass filters that remove higher order harmonics generated by the mixers 202 and 204. The outputs of the digital SAW filters 208 and 210 are digitized, passband I and Q signals that represent the real and imaginary components, respectively, of the received OFDM signal.

The outputs of the digital SAW filters 208 and 210 are coupled to the band edge timing recovery circuit 124. The band edge timing recovery circuit 124 comprises a pair of matched filter/complements 212 and 214, complex signal generator 216, positive band edge detector 218, negative band edge detector 220, complex conjugator 222, multiplier 224, phase detector 226, and a sampling clock 228. The matched filter/complements 212 and 214 receive the I and Q signals from the digital SAW filters 208 and 210, respectively. Each of the matched filter/complements 212 and 214 comprise a conventional matched filter, such as a root raised cosine filter, and a bandedge filter that is the complement of the matched filter. The conventional matched filter has a bandwidth so as to pass the entire frequency spectrum of the OFDM signal (i.e., a spectrum including all of the sub-carriers). The bandedge filter passes only the upper and lower band edges of the OFDM signal (i.e., the band edge of the highest frequency sub-carrier and the band edge of the lowest frequency sub-carrier).

The matched filter/complements 212 and 214 produce at their output I and Q low pass filtered output signals and I and Q complementary high pass filtered signals, respectively. The I and Q low pass filtered output signals are matched to the transmit pulse shape of the OFDM signal (i.e., a frequency spectrum including all of the sub-carriers) and are coupled to the complex programmable delay circuit 122. The I and Q complementary high pass filtered output signals are used for band edge timing recovery and are supplied to the complex signal generator 216. Specifically, the I and Q high-pass signals comprise a double sideband suppressed carrier amplitude modulated (AM) signal that contain frequency and phase offsets useful to timing recovery.

The complex signal generator 216 combines the I and Q high-pass signals from the matched filter/complements 212 and 214 to generate a complex signal in a known manner. The resulting complex signal contains positive and negative high frequency components marking the band edges of the received OFDM signal and is supplied to the positive band edge detector 218 and the negative band edge detector 220. The positive and negative band edge detectors 218 and 220 are, for example, Hilbert filters. The positive and negative band edge detectors 218 and 220 extract the positive and negative high frequency components of the complex signal, respectively. The complex product of one high frequency component with the complex conjugate of the other high frequency component is produced by the combination of the complex conjugator 222 and the multiplier 224.

To generate the timing signal for the complex programmable delay 122, the output of the multiplier 224 is coupled to the phase detector 226. The phase detector 226 detects one complex component, for example the imaginary component, of the output from the multiplier 224 and generates a phase error signal. The phase error signal is coupled to the sampling clock 228. The sampling clock 228 uses the phase error signal to generate a timing signal, which is coupled to the complex programmable delay 122.

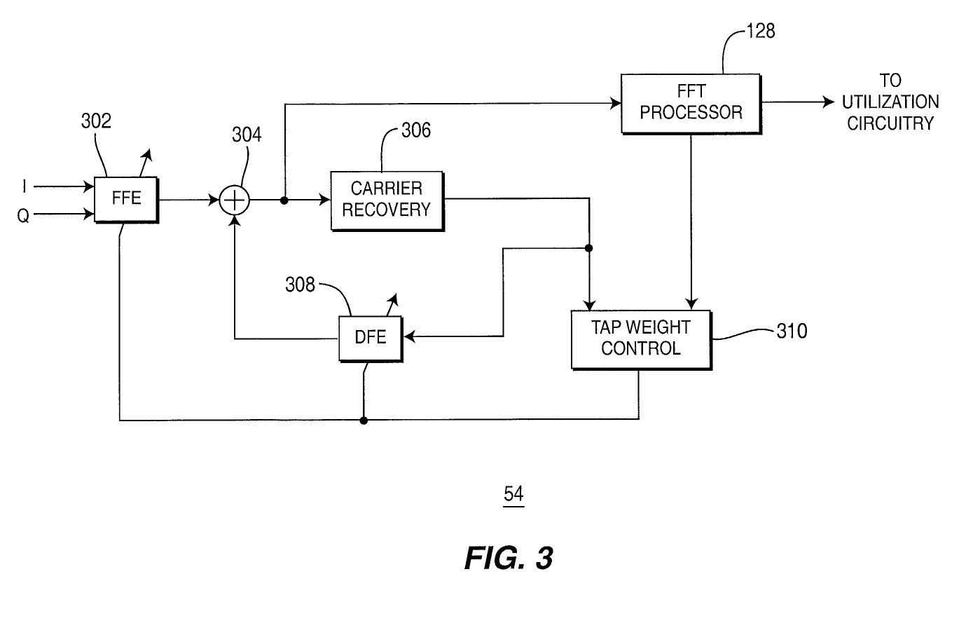

The complex programmable delay 122 comprises a dynamic delay line, which has as input the low pass I and Q signals from the matched filter/complements 212 and 214. The dynamic delay line is modulated with the timing signal from the sampling clock 228 to adjust the symbol timing delay. In essence, the complex programmable delay 122 acts as an interpolation filter that re-samples the I and Q signals using interpolative sampling in response to the timing signal generated by the bandedge timing circuit 124. Thus, the complex programmable delay circuit 122 re-samples the I and Q signals at an optimal sampling point to generate synchronized I and Q near baseband signals. The synchronized I and Q near baseband signals are supplied to the signal processor 54 for further processing as described below with regard to FIG. 3.

FIG. 3 depicts a more detailed block diagram of the signal processor 54. Specifically, in one embodiment of the invention, the adaptive equalizer 126 comprises a feed forward equalizer (FFE) 302, a signal combiner 304, a carrier recovery circuit 306, a decision feedback equalizer (DFE) 308, and a tap-weight controller 310. The tap-weight controller 310 sets the tap weight coefficients of the FFE 302 and the DFE 308 upon initial signal acquisition, and adjusts the coefficients in response to changes in the transmission channel during reception of the OFDM signal. The tap weight controller 310 receives signals from both the adaptive equalizer 126 and the FFT processor 128. In the present embodiment, the adaptive equalizer 126 is a “blind” equalizer, in that, it does not require a “training sequence” to initialize the tap weight coefficients. As such, the tap weight coefficients are adjusted in view of the adaptive equalizer 126 output signal and a control signal from the FFT processor 128.

Specifically, the tap weight controller 310 can execute blind equalization algorithms to adjust the tap weights. Blind equalization algorithms for use with the present invention include, but are not limited to, the well known constant modulus algorithm (CMA), or the modified constant modulus algorithm (M-CMA) described in U.S. patent application Ser. No. 09/828,324 (attorney docket number SAR 14209), entitled “METHOD AND APPARATUS FOR EQUALIZING A RADIO FREQUENCY SIGNAL”, which is herein incorporated by reference. Once the OFDM signal has been acquired, the adaptive equalizer 126 can switch into a decision directed mode. In addition, feedback from the FFT process in the form of a control signal from the FFT processor 128, albeit delayed feedback, is further used to adjust the tap weights. In one embodiment, the control signal from the FFT processor 128 contains information regarding the absence of pilot carriers embedded in the OFDM signal. Such information is useful to identify portions of the channel that are experiencing severe multipath distortion, such as frequency selective fading in the channel.

Returning to FIG. 3, the FFE 302 is a multi-tap equalizer that has the I and Q signals from the complex programmable delay 122 as input, and a temporally equalized baseband OFDM signal as output. The output of the FFE 302 is coupled to the signal combiner 304, where it is combined with the output of the DFE 308. The output of the signal combiner 304 is coupled to the carrier recovery circuit 306. The carrier recovery circuit 306 corrects for any frequency or phase offset in the received OFDM signal, thus mitigating some of the Doppler effects affecting the entire OFDM signal band. The output of the carrier recovery circuit 306 is coupled to the DFE 308 for temporal equalization and removal of ISI. In addition, the output of the carrier recovery circuit 306 is coupled to the tap-weight controller 310. As discussed above, the tap-weight controller 310 uses the output of the carrier recovery circuit 306 and a control signal from the FFT processor 128 to adjust the tap weight coefficients of the FFE equalizer 302 and the DFE equalizer 308. In this manner, the adaptive equalizer 126 corrects for Doppler shifts of the entire OFDM signal band and, using feedback from the FFT processor 128, corrects for multipath distortion affecting individual sub-carriers.

The equalized baseband OFDM signal at the output of the signal combiner 304 is further coupled to the FFT processor 128. The FFT processor 128 performs an FFT operation in a known manner to demodulate the OFDM sub-carriers and produce a stream of frequency domain sub-symbols that encode the data stream. In the present embodiment, the FFT processor 128 is disposed after the adaptive equalizer 126, which allows for immediate feedback from the DFE 308 resulting in better performance for frequency selective radio channels. Information obtained from sub-carrier recovery is used to indicate the channel regions under severe impact by determining the absence of specific pilot carriers. Thus, a control signal is generated and coupled to the tap-weight controller 310 to adjust the tap weight coefficients in the adaptive equalizer 126.

While foregoing is directed to the preferred embodiment of the present invention, other and further embodiments of the invention may be devised without departing from the basic scope thereof, and the scope thereof is determined by the claims that follow.

1. An apparatus for demodulating an orthogonal frequency division multiplexed (OFDM) signal comprising:
a band edge timing recovery circuit for tracking a symbol timing error in the OFDM signal, the band edge timing circuit having a band edge timing signal as output;
a delay compensation circuit responsive to the band edge timing signal for optimally re-sampling the OFDM signal to mitigate the symbol timing error; and
a demodulator for recovering data contained in the re-sampled OFDM signal.

2. The apparatus of claim 1 wherein the demodulator comprises:
an adaptive equalizer for removing intersymbol interference from the OFDM signal, the adaptive equalizer having a baseband OFDM signal as output; and
a fast Fourier Transform (FFT) processor for demodulating sub-carriers of the baseband OFDM signal to produce an encoded data signal.

3. The apparatus of claim 1 wherein the band edge timing circuit comprises:
a matched filter/complement for filtering the OFDM signal to produce a band edge signal having positive and negative high-frequency components marking the band edges of the OFDM signal;
a positive band edge detector for extracting the positive high-frequency component from the band edge signal;
a negative band edge detector for extracting the negative high-frequency component from the band edge signal;
a complex multiplier/conjugation circuit for generating a complex product of the positive high-frequency component with the conjugate of the negative high-frequency component;
a phase detector for processing the complex product, the phase detector having an error signal as output; and
a sampling clock for generating the band edge timing signal from the error signal.

4. The apparatus of claim 3 wherein the positive and negative band edge detectors are Hilbert filters.

5. The apparatus of claim 2 wherein the adaptive equalizer comprises:
a feed forward equalizer (FFE);
a decision feedback equalizer (DFE);
a combiner for combining the output signals from the FFE and the DFE;
a carrier recovery circuit for extracting the carrier from the output signal from the combiner; and
a tap weight controller for adjusting the tap weights of the FFE and the DFE using the output of the carrier recovery circuit and a control signal from the FFT processor.

6. A method of demodulating an orthogonal frequency division multiplexed (OFDM) signal comprising:
producing a band edge timing signal from the OFDM signal;
re-sampling the OFDM signal at an optimal point in response to the band edge timing signal; and
demodulating the re-sampled OFDM signal to recover data contained in the OFDM signal.

7. The method of claim 6 wherein the step of demodulating the re-sampled OFDM signal comprises:
equalizing the OFDM signal to remove intersymbol interference; and
performing a fast Fourier Transform (FFT) process for demodulating sub-carriers of the OFDM signal to generate an encoded data signal.

8. The method of claim 6 wherein the step of producing a band edge timing signal comprises:
filtering the OFDM signal to produce a band edge signal having positive and negative high-frequency components marking the band edges of the OFDM signal;
extracting the positive and negative high-frequency components from the band edge signal;
producing a complex product of the positive high-frequency component with the conjugate of the negative high-frequency component;
generating an error signal from the complex product; and
generating the band edge timing signal from the error signal.

9. The method of claim 8 wherein the step of extracting the positive and negative high-frequency components comprises filtering the complex signal through Hilbert filters.
